(19) United States
(12) Patent Application Publication
(10) Pub. No.: US 2026/0368029 A1
(43) Pub. Date: Nov. 19, 2026

(54) FUNCTIONAL SAFETY FOR OPEN CHIPLET ARCHITECTURE

(71) Applicant: Tenstorrent USA, Inc., Austin, TX (US)

(72) Inventors: Samuel Paul Visalli, Allen, TX (US); Zhimin Chen, San Jose, CA (US)

(21) Appl. No.: 19/678,883

(22) Filed: May 15, 2026

Related U.S. Application Data
(60) Provisional application No. 63/807,880, filed on May 18, 2025.
(60) Provisional application No. 63/860,271, filed on Aug. 8, 2025.

(51) Int. Cl. G06F 11/07

(52) U.S. Cl. CPC G06F 11/0793; G06F 11/0721

(57) ABSTRACT

Systems and methods related to functional safety for open chiplet architectures are disclosed herein. A network may include a plurality of chiplets. One of the chiplets may include a primary safety entity and each other chiplet in the network may include a secondary safety entity coupled with the primary safety entity. The secondary safety entities may send one or more safety communications concerning an error of the respective chiplet to the primary safety entity and may address the error. A plurality of functional safety messaging channels may connect each chiplet to the primary safety entity. The functional safety messaging channels may support safety communication between the primary safety entity and the chiplets. A plurality of interrupt channels may also connect each chiplet to the primary safety entity. The network may provide improved functional safety.

### CROSS REFERENCE TO RELATED APPLICATIONS

This application claims the benefit of U.S. Provisional Patent Application No. 63/807,880, filed May. 18, 2025, and of U.S. Provisional Application No. 63/860,271, filed Aug. 8, 2025, each of which are incorporated by reference herein in their entirety for all purposes.

### BACKGROUND

The present description relates to functional safety (FuSa) for chiplet architectures. Functional safety is a discipline focused on ensuring that systems—including hardware and software—operate safely by automatically detecting and controlling potentially dangerous faults or failures, thereby minimizing risks to human life and property. It involves designing systems to perform correctly under both normal and fault conditions, using mechanisms such as error detection, fault mitigation, and safe-state transitions to prevent hazardous events. Functional safety standards, like ISO 26262 for automotive and IEC 61508 for industrial applications, define rigorous processes and requirements to reduce the probability of dangerous failures to an acceptable level. These standards classify safety integrity levels, reflecting the severity and likelihood of risks, and guide manufacturers in identifying, assessing, and mitigating safety hazards throughout the product lifecycle. In essence, functional safety aims to ensure that safety-related systems, such as those found in vehicles or industrial equipment, handle failures gracefully without causing harm.

Functional safety for a network of chiplets addresses the challenge of ensuring system-wide operational safety and fault tolerance for the network. Chiplets are small, specialized integrated circuits designed to function as individual components in a larger system of which they form a part. Chiplets are then integrated together to form a system, such as a System in Package (SiP), which behaves like a traditional monolithic silicon chip, especially from high-level software perspective. Chiplets are assembled into a single package and interconnected using high-speed, standardized interfaces such as UCIe. Unlike traditional monolithic integrated circuits where all functions are manufactured together on a single piece of silicon, chiplets may be designed, fabricated, and assembled separately.

The chiplet approach allows for greater flexibility, improved yields, higher cost efficiency, and shorter time to market. While a chiplet-based SiP offers appealing advantages, it also brings new challenges to the SiP development, especially interoperability among various chiplets. The chiplet approach introduces new complexities in managing interaction between heterogeneous components—especially as these components may originate from different vendors and manufacturing processes. In safety-critical domains like automotive or industrial systems, strict standards require each chiplet and the system as a whole to operate reliably, detect or mitigate random hardware failures, and prevent the propagation of faults that could endanger life or property. Functional safety mechanisms in such environments include end-to-end data protection (like CRC and retry protocols), watchdog timers, diagnostic coverage, and comprehensive verification to ensure correct operation, interoperability, and compliance with rigorous safety requirements. As chiplet systems grow increasingly complex, the collaborative validation, certification, and standardized management of functional safety across the entire network become crucial for achieving the necessary reliability and regulatory approval demanded by automotive, aerospace, and industrial markets.

A network of different chiplets may require certain regulations for interoperability. In applications like automotive, robotics, and factory automation, failures can lead to catastrophic outcomes; these applications bring additional Functional Safety requirements. Functional Safety focuses on avoiding unreasonable risk of harm. For example, a functional safety subsystem of an automotive system may prioritize preventing a car crash over keeping the automotive system functional, as the consequences of a car crash may be more severe to the user than the consequences of a period of inoperability of aspects of the automotive system. Functional Safety systems may be required to comply with standards and safety laws.

### SUMMARY

Chiplets are networked together to provide a system with functional safety. Chiplets may be connected to a primary safety entity via one or more functional safety messaging channels. The primary safety entity may be part of a functional safety primary chiplet. The other chiplets may be secondary chiplets and may include secondary functional safety entities. Chiplets may be connected to the primary safety entity directly via a single functional safety messaging channel or may be connected to the primary safety entity indirectly through multiple functional safety messaging channels and other chiplets in the network. In specific embodiments, the functional safety messaging channels may connect the network of chiplets in a daisy chain topology, tree topology, or another hierarchical topology. The functional safety messaging channels may provide communication paths amongst the chiplets.

Chiplets may be connected to the primary safety entity via one or more interrupt channels. In specific embodiments, the one or more interrupt channels may be physically separate from the one or more functional safety messaging channels. Chiplets may be connected to the primary safety entity directly via an interrupt channel or may be connected to the primary safety entity indirectly through multiple interrupt channels and other chiplets in the network. An interrupt line directly coupled with a chiplet may assert (e.g., activate to high) when there is a fault in that chiplet. Upon detecting the fault, the primary safety entity may query back through the network of chiplets (e.g., daisy-chained network) using the one or more functional safety messaging channels to find the source of the error.

Each chiplet may include its own secondary safety entity. The secondary safety entities may perform some responsibilities that would otherwise belong to the primary safety entity. The inclusion of secondary safety entities may make the chiplets more self-contained. Using its secondary safety entity, a chiplet may respond to errors, perform self-tests, perform setup, and perform other types of safety functions. Secondary safety entities may relay messages to the next chiplet on the chain, facilitating communication in the network. Chiplets may send a message over the one or more functional safety messaging channel to the primary safety entity indicating that a chiplet had an error. Before the chiplet receives a response from the primary safety entity, the chiplet’s secondary safety entity may already be handling the error. For example, the secondary safety entity may put the chiplet into reset or otherwise try to correct the error.

In specific embodiments, the functional safety messaging channels may be compliant with generic messaging architecture of open chiplet architecture (OCA). The functional safety messaging channels may be dedicated channels that are focused on safety. Functional safety messaging channels may have properties beyond generic messaging channels. For example, some properties assigned to the messaging channel may be related to error detection, sequence numbers, protecting the content of the message, periodic timeout messages (e.g., to make sure the link is still alive), and the like. The functional safety messaging channel properties may be based on safety considerations.

In specific embodiments, the hardware of the functional safety messaging channels may be shared with other channels; in specific embodiments, the hardware of the functional safety messaging channels is only used for the functional safety applications and not shared with other channels. Using separate (e.g., not shared) physical communications channels for functional safety messaging may improve the safety of the system. Physically separate interrupt lines in addition to the functional safety messaging channels may similarly improve safety. For example, even if a functional safety messaging channel has a fault or error, the primary safety entity may still receive interrupt. The primary safety entity may assume worst case scenario and implement safety measures accordingly. For example, the safety entity may implement measures to prevent a car crash if the chiplet network is part of an automotive system.

In specific embodiments of the invention, a network of chiplets is provided. The network comprises: a plurality of chiplets, each chiplet including a safety entity; and a primary safety entity coupled with each safety entity. The safety entity of each chiplet is configured to: send one or more safety communications about a chiplet error of the corresponding chiplet to the primary safety entity; and address the chiplet error of the corresponding chiplet. Addressing the chiplet error can be done by placing the chiplet into reset or initiating a corrective action for the chiplet error.

In specific embodiments of the invention, a network of chiplets is provided. The network comprises: a plurality of chiplets, a primary safety entity, and a plurality of functional safety messaging channels connecting each chiplet in the plurality of chiplets to the primary safety entity. The plurality of functional safety messaging channels are configured to carry safety communication between the primary safety entity and the plurality of chiplets.

In specific embodiments of the invention, a network of chiplets is provided. The network comprises: a plurality of chiplets, each chiplet including a safety entity; and a plurality of chiplet connections connecting the plurality of chiplets in a directed tree topology. The safety entity of each chiplet aggregates safety information from downstream chiplets in the plurality of chiplets and safety information of the corresponding chiplet; and transmits the aggregated safety information to an upstream chiplet in the plurality of chiplets.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a layered model of a chiplet architecture in accordance with specific embodiments of the inventions disclosed herein.

FIG. 2 illustrates an example of a Functional Safety topology in a SiP in accordance with specific embodiments of the inventions disclosed herein.

FIG. 3 illustrates an example of a topology for interrupt forwarding in accordance with specific embodiments of the inventions disclosed herein.

FIG. 4 illustrates an SiP with safety entities, functional safety messaging channels, and interrupt channels in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for functional safety (FuSa) for chiplet architectures in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In applications like automotive, robotics, and factory automation, failures can lead to catastrophic outcomes. These applications bring additional Functional Safety requirements. There may be interoperability requirements for Functional Safety features, as well as Functional Safety requirements associated with the logic introduced to ensure interoperability.

The present disclosure provides a functional safety architecture for a network of chiplets assembled into a System-in-Package (SiP). Each chiplet in the network may include a Safety Entity, and the chiplets may be organized into a Directed Tree topology in which each secondary safety entity aggregates safety information from downstream chiplets together with locally generated safety information and forwards the combined result upstream toward a primary safety entity at the root of the tree. Communication between the chiplets and the primary safety entity may be carried over at least two physically separate channel types: a wired interrupt channel comprising dedicated point-to-point conductors, and a functional safety messaging channel whose properties (e.g., error detection codes, sequence numbering, timeout enforcement, and periodic heartbeat messages) may be derived from safety requirements. The wired interrupt channels may be further separated into physically distinct fatal and non-fatal interrupt channels. The physical separation of channels may ensure that a fault in the messaging channel does not prevent the primary safety entity from receiving fault notification through the interrupt channel, allowing the primary safety entity to initiate protective measures even in the absence of detailed diagnostic information.

When direct interrupt connections between every chiplet and the primary safety entity are impractical due to physical layout constraints or limited interrupt input capacity, intermediate chiplets may forward interrupt signals toward the primary safety entity and record aggregation information identifying which downstream chiplets contributed to their output interrupt state. Upon receiving a forwarded interrupt, the primary safety entity may conduct a query-chain traversal over the functional safety messaging channel, sequentially querying intermediate chiplets until the original faulting chiplet is identified. A software-controlled self-test mechanism may detect open-circuit and short-circuit faults in the wired interrupt lines. The primary safety entity may initiate a self-test over the FuSa messaging channel, and the targeted secondary safety entity may assert its interrupt output under software control to confirm end-to-end electrical continuity of the wire.

A safety entity on a chiplet may be configured to send one or more safety communications to a primary safety entity, which may be on another chiplet. As used herein, the term "safety communication" refers to any communication transmitted over a functional safety messaging channel in support of functional safety operation of the network of chiplets. Safety communications include, without limitation: error message-based communications reporting a fault or fault status; query messages requesting information about a fault, an interrupt source, or another safety condition; response messages transmitted in reply to query messages; self-test initiation commands and corresponding response or completion messages; configuration commands to set, modify, or query safety configuration parameters of a chiplet (e.g., parameters governing heartbeat intervals, recheck delays, interrupt forwarding behavior, aggregation behavior, fault-response policy, and safety integrity level); heartbeat messages to verify the integrity of one or more functional safety messaging channels; interrupt-clearing messages to de-assert an interrupt wire; aggregation information messages reporting which downstream chiplets contributed to an asserted output interrupt state; and any other message transmitted over a functional safety messaging channel that relates to the establishment, maintenance, verification, configuration, diagnosis, or operation of functional safety within the network of chiplets. A communication is a safety communication regardless of whether it originates from the primary safety entity, from a secondary safety entity, or from another safety entity, and regardless of the direction in which it travels over the functional safety messaging channel. Reference herein to error message-based communication is a non-limiting example of a safety communication and is not intended to exclude other forms of safety communication unless expressly stated.

The polarity convention used herein for describing interrupt wire signaling is illustrative and not limiting. Throughout this disclosure, references to an interrupt wire being asserted "high" or "active high," or to an interrupt wire being driven to a logical one or to a particular voltage level, are intended to denote the state of the interrupt wire that indicates the presence of an interrupt condition, regardless of the specific physical signaling convention used in a particular implementation. In specific embodiments, the asserted state of an interrupt wire may be implemented as a high voltage level, a logical one, a low voltage level, a logical zero, a differential signal, a transition between levels, or any other physical convention by which the interrupt wire can convey the presence of an interrupt condition to a receiving chiplet. References herein to driving an interrupt wire "high" or "low" should be understood as describing the assertion or de-assertion of the interrupt wire under the polarity convention adopted for the particular embodiment being described, and should not be construed as limiting the disclosure to a specific physical polarity.

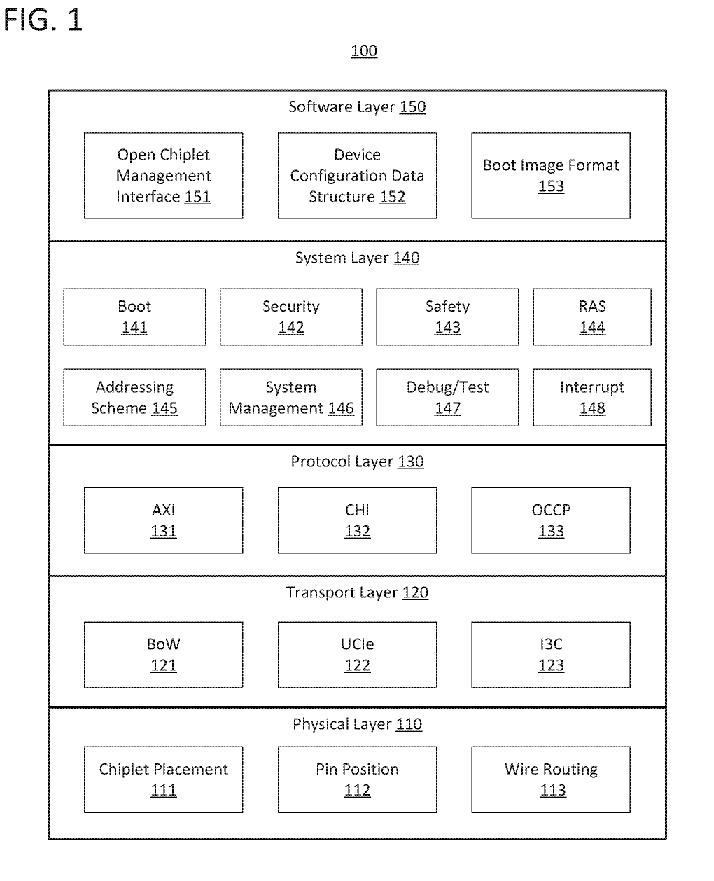

FIG. 1 illustrates layered model 100 of a chiplet architecture in accordance with specific embodiments of the inventions disclosed herein. In the illustrated embodiment, the architecture is organized into physical layer 110, transport layer 120, protocol layer 130, system layer 140, and software layer 150. Layered model 100 is a conceptual representation showing that chiplet interoperability, including functional safety interoperability, can be addressed across multiple layers. The functional safety architecture disclosed herein may operate primarily at system layer 140, while relying on transport layer 120 and protocol layer 130 to carry FuSa messaging channel traffic and interrupt channel traffic between chiplets.

Physical layer 110 may define physical integration aspects of the chiplet system, such as chiplet placement 111, pin position 112, and wire routing 113. Physical layer 110 may represent package-level and physical-implementation considerations used to physically realize communication among chiplets.

Transport layer 120 may provide mechanisms for transferring data between chiplets. In the illustrated example, transport layer 120 includes Bunch of Wires (BoW) 121, Universal Chip Interconnect Express (UCIe) 122, and Improved Inter-Integrated Circuit (I3C) 123. These transport mechanisms are shown as examples of lower-layer communication technologies by which information may be conveyed among chiplets, other mechanisms may be used.

Protocol layer 130 may define mechanisms for interpreting data, packets, messages, transactions, or other communication units and for mapping such communications to local fabrics, higher-level system functions, or buses. In the illustrated example, protocol layer 130 includes AXI 131, CHI 132, and Open Chiplet Configuration Protocol (OCCP) 133. OCCP may be a boot and system management protocol. These protocol examples are illustrative, and other protocol arrangements may be used in other embodiments. In specific embodiments, the FuSa messaging channel disclosed herein may use a dedicated safety protocol, such as the Open Chiplet Safety Protocol (OCSP), at protocol layer 130. The protocol properties of the FuSa messaging channel may be derived from functional safety requirements.

System layer 140 may define system-level functionality distributed across multiple chiplets. In the illustrated example, system layer 140 includes Boot 141, Security 142, Safety 143, Reliability, Availability, Serviceability (RAS) 144, Addressing Scheme 145, System Management 146, Debug/Test 147, and Interrupt 148. These system-layer functions represent architectural functions that enable chiplets to operate together as a coordinated and coherent system. Safety 143 may encompass the hierarchical directed-tree topology of Safety Entities, the dual physically separate channel architecture comprising wired interrupt channels and FuSa messaging channels, the interrupt forwarding and query-chain traversal mechanisms, the autonomous fault-handling behavior of Secondary Safety Entities, software-controlled interrupt self-test mechanisms, heartbeat-based channel integrity monitoring, and post-clearing interrupt recheck mechanisms.

Software layer 150 may define software-visible interfaces and data structures used to configure, manage, and support operation of the chiplet system. Software layer 150 may define standard device configuration data structures and software interfaces. In the illustrated example, software layer 150 includes Open Chiplet Management Interface 151, Device Configuration Data Structure 152, and Boot Image Format 153. Device Configuration Data Structure 152 may include topology information describing the directed-tree arrangement of chiplets, the interrupt forwarding connections among chiplets, and the aggregation relationships among Safety Entities, enabling the primary safety entity to conduct query-chain traversal to identify the source of a forwarded interrupt.

In some embodiments of the present disclosure, one or more architectural inter-chiplet channels are defined at system layer 140. For example, an architectural channel may correspond to a system-layer function or functional domain such as boot, system management, security, interrupt handling, debug/test, or safety. The architectural channel may thus be maintained as a system-layer construct independently of any particular lower-layer implementation.

The layered arrangement shown in FIG. 1 is illustrative and non-limiting. In various embodiments, one or more layers may be combined, subdivided, omitted, supplemented, or otherwise implemented differently. Likewise, the particular examples shown within each layer are illustrative and do not limit the scope of the disclosed embodiments.

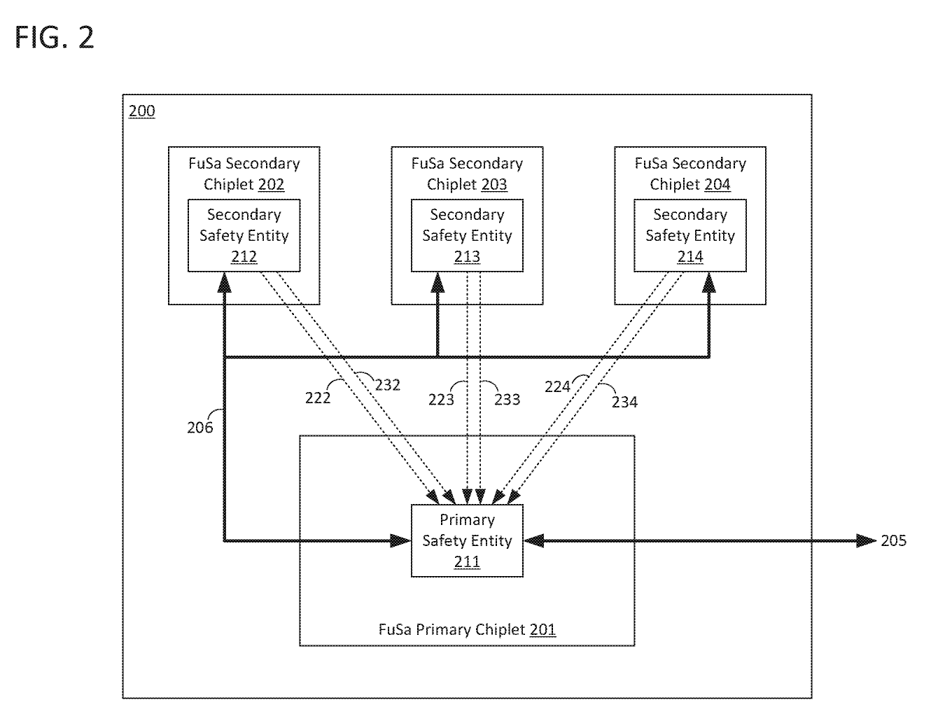

FIG. 2 shows an example of the Functional Safety topology in a SiP 200 in accordance with specific embodiments of the inventions disclosed herein. SiP 200 may be an automotive SiP or may be used in other safety-critical applications such as robotics or industrial automation. FuSa primary chiplet 201 includes primary safety entity 211. FuSa secondary chiplets 202, 203, and 204 include secondary safety entities 212, 213, and 214 respectively. Open chiplet architecture may employ a hierarchical approach for Functional Safety management. From an open chiplet architecture Functional Safety perspective, chiplets in a package and their connections may form a Directed Tree, a subset of a Directed Acyclic Graph. The topology may include roots, leafs, and non-leafs organized upstream and downstream relative to each other. A leaf may be an end chiplet with no downstream chiplet. A non-leaf may be an intermediate chiplet with at least one upstream chiplet and one downstream chiplet. In this topology, the upstream chiplet receives and processes safety information from the downstream chiplets. Primary safety entity 211 may sit at the root of the tree of safety entities and may aggregate all safety information within SiP 200. As shown in FIG. 2, SiP 200 includes three distinct channel types connecting the secondary chiplets to primary safety entity 211: fatal error interrupt wires 222, 223, and 224; non-fatal interrupt wires 232, 233, and 234; and FuSa messaging channel 206. The physical separation of these channel types from one another may be a structural feature of SiP 200.

Chiplets in a package and their connections may form a Directed Acyclic Graph. Each node in the graph may be a chiplet. The edges may indicate physical connections between chiplets. Following the direction of a directed edge, the graph moves from an upstream chiplet to a downstream chiplet. The upstream chiplet is at the same or higher management level than the downstream. The topology root (primary) of a directed acyclic graph may be the primary chiplet in a function domain. Upstream chiplets of a specific chiplet may refer to all chiplets that have a directed path to that specific chiplet. Downstream chiplets of a specific chiplet may refer to all chiplets that can be reached from that specific chiplet via a directed path. In SiP 200, secondary safety entities 212, 213, and 214 are each directly downstream of primary safety entity 211, forming a single-level directed tree in which all secondary chiplets report directly to the primary. In other embodiments, secondary chiplets may be connected to primary safety entity 211 indirectly through one or more intermediate chiplets, forming a deeper directed tree topology.

Chiplets 202, 203, and 204, support safety applications and accordingly implement safety entities 212, 213, and 214 respectively to handle local safety-related tasks. Each secondary (e.g., local) Safety Entity may aggregate both the internal safety information from its own chiplet and the safety information received from downstream chiplets. In the embodiment of SiP 200, each secondary chiplet 202, 203, 204 is a leaf node with no downstream chiplets of its own, and accordingly each of secondary safety entities 212, 213, and 214 forwards only locally generated safety information. In embodiments where a secondary chiplet is a non-leaf node, its secondary safety entity performs the additional aggregation function. Eventually, the primary safety entity 211 may aggregate all safety information in SiP 200.

Each secondary safety entity 212, 213, 214 may also be configured to begin addressing a detected fault autonomously, without waiting for instruction from primary safety entity 211, thereby reducing the interval between fault occurrence and initial containment. For example, a secondary safety entity may place its own chiplet into reset or initiate another local corrective action before receiving a response from primary safety entity 211. The autonomous fault-handling capability of the secondary safety entity reduces the time between fault occurrence and initial containment, which is critical in applications with strict fault-response timing requirements. The secondary safety entity subsequently notifies the primary safety entity through the interrupt and messaging channels, allowing the primary safety entity to coordinate a system-level response in parallel with the local containment already underway.

Primary safety entity 211 may collect all information regarding the ability of SiP 200 to continue operating fault-free; respond by transitioning the SiP into a safe, or fault detected, state when necessary; and communicate this status to external world 205. When a secondary chiplet encounters an internal fault that could impact the system’s safe operation, like an internal bus timeout, an uncorrectable error correction code (ECC) error, or a system hang, it may signal the fault to primary safety entity 211. The appropriate response to such a fault is often highly system-specific, such as resetting the affected chiplet or transitioning the entire system to a safe state, making it the responsibility of primary safety entity 211 to handle the fault in an application-specific manner. In cases where a non-fatal fault is not addressed within the time frame required by the applicable safety concept, the non-fatal fault may escalate to a fatal fault, and primary safety entity 211 may respond accordingly. The primary safety entity may respond with sufficient speed, as defined by the system’s safety concept, to address these faults.

In specific embodiments, FuSa primary chiplet 201 may be a base chiplet, where the essential functions of the SiP may be implemented. Primary safety entity 211 may either handle faults internally or forward them to an external safety Microcontroller Unit (MCU) in external world 205. In specific embodiments, the primary safety entity may be located within a dedicated safety MCU inside the SiP, where faults may be directly managed and addressed. The primary chiplet may then have a secondary safety entity. The connection to external world 205 may also serve as a reporting path through which primary safety entity 211 communicates the overall safety status of SiP 200 to a board-level controller or system-level safety monitor.

Functional Safety interoperability may involve standard interrupts that allow downstream chiplets with FuSa requirements to notify upstream FuSa chiplets of FuSa events. Each secondary chiplet 202, 203, and 204 may source two interrupt signals carried over two dedicated and physically separate point-to-point wires connecting to primary safety entity 211: a fatal error interrupt wire and a non-fatal interrupt wire. Fatal error interrupt wires 222, 223, and 224 connect secondary safety entities 212, 213, and 214 respectively to primary safety entity 211 and may carry fatal error interrupt signals. Non-fatal interrupt wires 232, 233, and 234 connect secondary safety entities 212, 213, and 214 respectively to primary safety entity 211 and may carry non-fatal error and status interrupt signals. Each wire may operate as a dedicated point-to-point conductor independently of any protocol stack or shared bus fabric, and independently of the other interrupt wire sourced by the same chiplet, such that a fault affecting one wire may not affect the signaling capability of the other.

Both the fatal error interrupt signal and the non-fatal interrupt signal may be implemented as level-sensitive, active-high signals that may not require clock synchronization to be detected by primary safety entity 211. In specific embodiments, the fatal interrupt signals and non-fatal interrupt signals may be asserted using means other than being set to high. For example, the asserted state of the interrupt wire may be high voltage level, a logical one, a low voltage level, a logical zero, a differential signal, a transition between levels, or any other physical convention by which the interrupt wire can convey the presence of an interrupt condition. The fatal error interrupt may be asserted (e.g., driven high) on fatal error interrupt wires 222, 223, or 224 to indicate that a fatal error has occurred in the corresponding chiplet and that the chiplet can no longer be relied upon to operate safely. For example, if the chiplet autonomously goes offline (e.g., thermal shutdown or unexpected reset), the fatal interrupt may be asserted. The fatal error interrupt may additionally be asserted during chiplet reset to indicate that the chiplet's function is unavailable, ensuring that primary safety entity 211 is notified of unavailability even when the chiplet is incapable of protocol-based communication. Examples of fatal errors include uncorrectable ECC errors and system hangs. The non-fatal interrupt may be asserted (e.g., driven high) on non-fatal interrupt wires 232, 233, or 234 to indicate that a non-fatal error or a status event has occurred in the corresponding chiplet. Examples of non-fatal errors include corrected ECC errors, and examples of status events include the completion of a self-test.

Upon receiving an asserted signal on any fatal error interrupt wire 222, 223, or 224 or any non-fatal interrupt wire 232, 233, or 234, primary safety entity 211 may query the corresponding secondary chiplet via FuSa messaging channel 206 to determine the nature and cause of the fault. Because fatal error interrupt wires 222, 223, and 224, non-fatal interrupt wires 232, 233, and 234, and FuSa messaging channel 206 are physically separate from one another, primary safety entity 211 may receive interrupt notifications and initiate protective measures even in the event that FuSa messaging channel 206 has itself suffered a fault, in which case primary safety entity 211 may assume a worst-case scenario and implement safety measures accordingly.

The fatal error interrupt may be driven high or otherwise asserted during chiplet reset to indicate that the chiplet's function is unavailable. The assertion of the fatal error interrupt during chiplet reset may establish a default-offline signaling convention that is structurally distinct from ordinary fault notification. Because fatal error interrupt wires 222, 223, and 224 may be asserted during reset of their respective secondary chiplets 202, 203, and 204, primary safety entity 211 may treat each such secondary chiplet as offline by default and may only cease to do so once the secondary chiplet completes its reset sequence and de-asserts its fatal error interrupt wire. This default-offline convention prevents a silent or unresponsive chiplet from being treated as healthy by primary safety entity 211. For example, if a secondary chiplet experiences a hang during reset, fails to complete its boot sequence, or otherwise remains in a non-functional state, its fatal error interrupt wire may remain asserted, and primary safety entity 211 may continue to treat the chiplet as unavailable. Conversely, in specific embodiments, only the affirmative de-assertion of the fatal error interrupt wire — performed by the secondary chiplet itself upon successful completion of reset — signals to primary safety entity 211 that the chiplet has transitioned to a functional state and may be relied upon for safe operation. This signaling convention may be enabled by the architectural property that fatal error interrupt wires 222, 223, and 224 are dedicated point-to-point conductors operating independently of any protocol stack, transport mechanism, or shared bus fabric. Because the assertion of a level-sensitive wire requires no clock, no protocol initialization, and no software execution on the secondary chiplet, the fatal error interrupt wire may be capable of conveying the unavailability state even when the secondary chiplet is incapable of any protocol-based communication, including during the earliest stages of chiplet reset and during fault conditions that prevent the chiplet from initializing its FuSa messaging channel interface.

FuSa messaging channel 206 connects all of chiplets 201, 202, 203, and 204. FuSa messaging channel 206 may enable chiplets 201 through 204 to exchange detailed information about functional safety events and commands. Unlike generic inter-chiplet messaging channels, the properties of FuSa messaging channel 206 may be derived from safety requirements. These properties may include cyclic redundancy checks for error detection, sequence numbers for detecting lost or reordered messages, timeout enforcement for detecting channel faults within a defined diagnostic interval, and periodic heartbeat messages that allow primary safety entity 211 to continuously verify the integrity of FuSa messaging channel 206 independently of any fault event. The heartbeat mechanism supports compliance with safety standards that require communication channel faults to be detectable within a specified time frame. FuSa messaging channel 206 may be used for self-test initiation, interrupt source query and response, interrupt cause query and response, and fault-clearing coordination between primary safety entity 211 and secondary safety entities 212, 213, and 214. In specific embodiments, the hardware of FuSa messaging channel 206 may be dedicated exclusively to functional safety applications and not shared with other inter-chiplet channels, further reducing the risk of inter-channel interference affecting safety communication.

In contrast to generic inter-chiplet messaging channels — including the application channels, system management channels, and other communication pathways that may exist within SiP 200 to support data movement, configuration, and management traffic — FuSa messaging channel 206 may be designed from the ground up around safety requirements rather than around bandwidth, latency, or throughput considerations. Generic inter-chiplet messaging channels are typically optimized to maximize the volume of data that can be transferred per unit time and to minimize the round-trip latency of transactions, with fault detection capability provided as a secondary feature sized to meet baseline reliability requirements rather than safety-critical diagnostic coverage targets. The properties of FuSa messaging channel 206, by contrast, are selected to maximize fault detection coverage, to bound the diagnostic time interval within which channel faults must be detectable, and to satisfy the specific safety integrity requirements imposed by applicable safety standards such as ISO 26262 for automotive applications and IEC 61508 for industrial applications. This bottom-up safety-oriented design results in a messaging channel architecture that may exhibit lower raw bandwidth and higher per-message overhead than a corresponding generic messaging channel, but that provides substantially greater confidence in the integrity of the communication and substantially greater coverage of the failure modes that are relevant to functional safety.

The specific property selections of FuSa messaging channel 206 reflect this design priority. Cyclic redundancy checks may be sized to provide a residual error rate consistent with the safety integrity level required by the applicable safety standard, rather than the lighter-weight checks typical of generic messaging channels. Sequence numbers may be required for every message rather than provided as an optional feature, ensuring that lost, reordered, or duplicated messages are reliably detected within bounded time. Timeout enforcement may be applied not only to individual transactions but also to channel idle intervals, such that the absence of expected traffic — including the absence of heartbeat messages — is itself treated as a diagnostic signal indicating a potential channel fault. The heartbeat mechanism may be required at all times during operation rather than enabled selectively, and the heartbeat interval may be selected based on the diagnostic time interval mandated by the applicable safety concept rather than based on bandwidth conservation. Message protection may include integrity codes covering not only the message payload but also routing and addressing information, preventing a corruption-induced misdelivery from masking a genuine fault report. Each of these property selections may differ from the corresponding selection that would be made for a generic inter-chiplet messaging channel optimized for performance, and the cumulative effect of these selections is a messaging channel architecture that is structurally distinct from generic messaging channels and that is suitable for use in safety-critical applications subject to standards such as ISO 26262 and IEC 61508.

Primary safety entity 211 and secondary safety entities 212, 213, and 214 may perform periodic self-tests to ensure that there are no permanent faults, such as short-circuit or open-circuit conditions, in fatal error interrupt wires 222, 223, and 224 or non-fatal interrupt wires 232, 233, and 234. Primary safety entity 211 may initiate self-tests with downstream secondary safety entities via FuSa messaging channel 206. The targeted secondary safety entity may respond by asserting the applicable interrupt wire under software control, allowing primary safety entity 211 to confirm end-to-end electrical continuity of that wire. Primary safety entity 211 may then respond via FuSa messaging channel 206 to clear the interrupt. The fatal error interrupt wire and the non-fatal interrupt wire of a given chiplet may each be tested independently, such that the integrity of each individual wire is verified separately. Chiplets may implement measures to ensure that if a real interrupt occurs on either the fatal error interrupt wire or the non-fatal interrupt wire during a self-test, this information can be communicated to primary safety entity 211, preventing a genuine fault from being masked by the test procedure.

Various mechanisms may be implemented to ensure that a genuine fault occurring during an active self-test is not masked by the test procedure. In specific embodiments, a secondary safety entity may maintain a state indicator — such as a register bit, flag, or other data field internal to the secondary safety entity — that distinguishes between an interrupt wire assertion caused by a self-test command and an interrupt wire assertion caused by a genuine fault. When primary safety entity 211 issues a self-test command via FuSa messaging channel 206 and the secondary safety entity asserts its interrupt wire under software control, the state indicator may be set to reflect the test-induced assertion. If a genuine fault is detected within the corresponding chiplet during the active self-test interval, the secondary safety entity may update the state indicator to reflect that a genuine fault is also present, and may report this state to primary safety entity 211 via FuSa messaging channel 206. In other embodiments, the secondary safety entity may transmit a separate fault-during-test message over FuSa messaging channel 206 immediately upon detecting the genuine fault, regardless of the current assertion state of the interrupt wire, allowing primary safety entity 211 to distinguish the genuine fault from the ongoing test. In further embodiments, the secondary safety entity may queue or latch the genuine fault information internally during the self-test interval and assert the corresponding interrupt wire upon completion of the test, ensuring that the genuine fault produces a detectable interrupt assertion separate from the one driven by software control. In still further embodiments, the secondary safety entity may use a separate interrupt wire — for example, the non-fatal interrupt wire when the fatal error interrupt wire is being tested, or vice versa — to signal a genuine fault that occurs during a self-test on the wire being tested. These mechanisms may be combined or implemented independently.

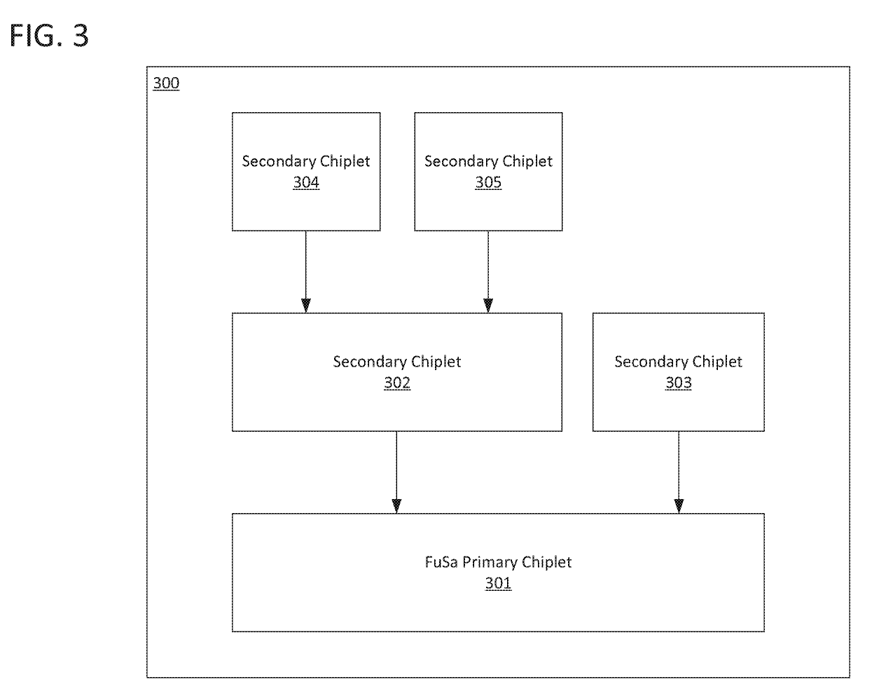

FIG. 3 illustrates an example of a topology for interrupt forwarding in accordance with specific embodiments of the inventions disclosed herein. SiP 300 includes FuSa primary chiplet 301, secondary chiplets 302 and 303 each directly connected to FuSa primary chiplet 301, and secondary chiplets 304 and 305 each connected to secondary chiplet 302. Secondary chiplets 304 and 305 are therefore indirectly connected to FuSa primary chiplet 301 through secondary chiplet 302, which acts as an intermediate aggregation node in the directed tree topology. Safety interrupts may be aggregated and forwarded between chiplets before reaching the primary safety entity. Aggregating and forwarding safety interrupts between chiplets before reaching the primary safety entity may be helpful for multiple reasons. For example, the designated FuSa primary chiplet may not have enough interrupt inputs to support all chiplets in the package. As another example, the physical layout of the SiP may make routing all interrupts directly to the FuSa Primary chiplet impractical. The interrupt forwarding architecture shown in FIG. 3 addresses both of these constraints by allowing secondary chiplet 302 to aggregate and forward interrupt signals from secondary chiplets 304 and 305 toward FuSa primary chiplet 301, without requiring direct interrupt connections between chiplets 304 and 305 and FuSa primary chiplet 301.

Forwarding refers to the simple relay of error interrupts. If a fatal or non-fatal input interrupt is detected on a chiplet that is not designated as the primary safety entity, the equivalent output interrupt from that chiplet may be asserted toward the next upstream chiplet. This can occur either through direct hardware connection or through software, where the Safety Entity may detect the input interrupt and set its own output interrupt. This can occur either through direct hardware connection, in which the input interrupt wire is physically tied to the output interrupt wire, or through software, in which the secondary safety entity of the intermediate chiplet detects the asserted input interrupt and sets its own output interrupt accordingly. In either case, the forwarding chiplet asserts its own output fatal error interrupt wire in response to an asserted input fatal error interrupt, and asserts its own output non-fatal interrupt wire in response to an asserted input non-fatal interrupt, preserving the distinction between fatal and non-fatal fault conditions across the forwarding chain.

When the primary safety entity receives a forwarded interrupt, it may initiate a query-chain traversal by querying the next chiplet in the forwarding chain via the FuSa messaging channel to determine the nature of the fault. That chiplet may report that the asserted interrupt was triggered by a downstream chiplet, identifying the next chiplet in the chain. The primary safety entity may then query that next chiplet, continuing the traversal until the original faulting chiplet is identified and can report the specific cause of the interrupt. Because the system topology is known in advance, the primary safety entity can conduct this traversal efficiently without requiring a broadcast query to all chiplets in the network.

For example, in SiP 300, if secondary chiplet 304 asserts a fatal interrupt, secondary chiplet 302, which receives the fatal interrupt from secondary chiplet 304 on its input fatal error interrupt wire, may assert its own output fatal error interrupt wire toward FuSa primary chiplet 301. FuSa primary chiplet 301 may first query secondary chiplet 302 via the FuSa messaging channel to determine the cause of the fatal interrupt, and secondary chiplet 302 may respond that the source is secondary chiplet 304. FuSa primary chiplet 301 may then, in some embodiments, directly query secondary chiplet 304 via the FuSa messaging channel to determine the specific cause of the fault. In other embodiments, FuSa primary chiplet 301 may query secondary chiplet 304 via secondary chiplet 302 since the FuSa messaging channel may not directly connect chiplets 301 and 304. Similarly, if secondary chiplet 305 asserts a fatal interrupt, secondary chiplet 302 may assert its output fatal error interrupt wire toward FuSa primary chiplet 301, and the same query-chain traversal applies, with secondary chiplet 302 identifying secondary chiplet 305 as the source upon query. The functional safety view of the SiP topology, including the interrupt forwarding connections among chiplets, may be included in the device configuration data structure to support this traversal.

A chiplet may have multiple input fatal errors in order to support aggregation, but only one output may be required, as multiple input errors may be aggregated into a single output interrupt, which may also include the chiplet's own internal fatal error. A parameter, FUSA_FATAL_CNT, may specify the number of input fatal error interrupt wires a given FuSa chiplet is capable of sinking from downstream chiplets. Each functional safety chiplet may be capable of sinking FUSA_FATAL_CNT input fatal error interrupts. The value of FUSA_FATAL_CNT may be profile-dependent but may be greater than or equal to one. In the example of SiP 300, secondary chiplet 302 sinks input fatal error interrupts from both secondary chiplet 304 and secondary chiplet 305, and accordingly implements a FUSA_FATAL_CNT of at least two, to accommodate the two downstream chiplets connected to it; chiplet 302 may also be able to accomodate its own internally generated fatal error. A leaf chiplet with no downstream connections may have FUSA_FATAL_CNT equal to zero, as it has no downstream chiplets from which to sink input fatal error interrupts. However, in specific embodiments, the leaf chiplet may still be capable of sinking at least one input fatal error interrupt from a downstream chiplet even if the specific topology of the chiplet system does not use this ability.. Regardless of the value of FUSA_FATAL_CNT, each FuSa chiplet may have only a single output fatal error interrupt wire. The output fatal error interrupt wire of a chiplet may be asserted in response to the assertion of any input fatal error interrupt wire of that chiplet, in response to the chiplet's own internally generated fatal error, or in response to both, such that the input fatal error interrupts from downstream chiplets and the chiplet's own internally generated fatal error are aggregated into a single output fatal error interrupt assertion. Each input fatal interrupt may be configurable via local software and/or messages from the primary safety entity to trigger the output fatal error.

A chiplet may have multiple input non-fatal errors in order to support aggregation, but only one output may be required, as multiple input errors may be aggregated into a single output interrupt, which may also include the chiplet's own internal non-fatal error. A parameter, FUSA_NONFATAL_CNT, may specify the number of input non-fatal error wires a given FuSa chiplet is capable of sinking from downstream chiplets. Each functional safety chiplet may be capable of sinking FUSA_NONFATAL_CNT input non-fatal interrupts. FUSA_NONFATAL_CNT may be profile-dependent but may be greater than or equal to one. In the example of SiP 300, secondary chiplet 302 sinks input non-fatal error interrupts from both secondary chiplet 304 and secondary chiplet 305, and accordingly implements a FUSA_NONFATAL_CNT of at least two, to accommodate the two downstream chiplets connected to it;, chiplet 302 may also be able to accommodate its own internally generated non-fatal error. A leaf chiplet with no downstream connections may have FUSA_NONFATAL_CNT equal to zero, as it has no downstream chiplets from which to sink input non-fatal error interrupts. However, in specific embodiments, the leaf chiplet may still be capable of sinking at least one input non-fatal error interrupt from a downstream chiplet even if the specific topology of the chiplet system does not use this ability. Regardless of the value of FUSA_NONFATAL_CNT, each FuSa chiplet may have only a single output non-fatal error interrupt wire. The output non-fatal error interrupt wire of a chiplet may be asserted in response to the assertion of any input non-fatal error interrupt wire of that chiplet, in response to the chiplet's own internally generated non-fatal error, or in response to both, such that the input non-fatal error interrupts from downstream chiplets and the chiplet's own internally generated non-fatal error are aggregated into a single output non-fatal error interrupt assertion. Each input non-fatal interrupt may be configurable via software and/or messages from the primary safety entity to trigger the output non-fatal error.

In specific embodiments, an interrupt from any functional safety chiplet may be sent to the functional safety primary chiplet, for example via a daisy chain. To shorten the interrupt path, chiplets can be configured to support more input interrupt pairs. For example, chiplets that may act as the functional safety primary chiplet can be designed to support a sufficient number of incoming interrupt pairs to eliminate the need for forwarding entirely. In specific embodiments, chiplets intended to serve as intermediate aggregation nodes can implement more than one input interrupt pair to support aggregation of interrupts from multiple downstream chiplets, as illustrated by secondary chiplet 302 in SiP 300.

When a functional safety chiplet aggregates interrupts from its downstream functional safety chiplets, it may record the aggregation information — including which downstream chiplets contributed to its asserted output interrupt state — and provide it to the primary safety entity when queried via the FuSa messaging channel, enabling the primary safety entity to precisely identify the source of a forwarded interrupt without requiring the primary safety entity to query every chiplet in the network.

The aggregation information recorded by a forwarding chiplet may be stored in any suitable data structure internal to the secondary safety entity of the forwarding chiplet. In specific embodiments, the aggregation information is stored in one or more registers within the secondary safety entity, with each register corresponding to a particular input interrupt wire and indicating whether that wire is currently asserted. In other embodiments, the aggregation information is stored in a table maintained by the secondary safety entity, in which each entry corresponds to a downstream chiplet connected to the forwarding chiplet and identifies the assertion state of the fatal error interrupt wire and the non-fatal interrupt wire received from that downstream chiplet. In further embodiments, the aggregation information is stored in a memory-mapped data structure accessible to the secondary safety entity through software, allowing the secondary safety entity to update the aggregation information in response to changes in input interrupt state and to read the aggregation information when responding to a query from the primary safety entity. The aggregation information may include separate fields for fatal error interrupt source identification and for non-fatal interrupt source identification, such that primary safety entity 431 can determine, in response to a single query, both which downstream chiplets contributed to an asserted fatal error interrupt wire of the forwarding chiplet and which downstream chiplets contributed to an asserted non-fatal interrupt wire of the forwarding chiplet. The aggregation information may further include timestamp information, sequence information, or other metadata indicating the order in which downstream interrupts were received, allowing the primary safety entity to identify the originating fault when multiple downstream interrupts are concurrently asserted.

When primary safety entity 431 receives an asserted output interrupt wire from a forwarding chiplet and queries that forwarding chiplet via the FuSa messaging channels to identify the source of the interrupt, the responding secondary safety entity may consult the aggregation information stored within it and may report at least a portion of the aggregation information to the primary safety entity. In specific embodiment, the portion may include the identity of the downstream chiplet or chiplets whose input interrupts caused the output interrupt assertion. If a reported downstream chiplet is itself a forwarding chiplet aggregating interrupts from further downstream chiplets, the primary safety entity may issue a subsequent query to that identified downstream chiplet, which consults its own aggregation information and reports its own contributing source or sources. This iterative query-and-response sequence may continue until the primary safety entity reaches a chiplet whose aggregation information identifies its own internal or local fault as the source of the interrupt, at which point the originating fault has been precisely identified. The recording of aggregation information at each forwarding chiplet, combined with the query mechanism over the FuSa messaging channels, enables precise fault source identification in arbitrarily deep forwarding chains without requiring the primary safety entity to maintain real-time visibility into the internal interrupt state of every chiplet in the network.

When a secondary safety entity has an interrupt to report from its own chiplet, it may assert the appropriate output interrupt wire. When a secondary safety entity receives an incoming interrupt from a downstream chiplet, it may forward it toward the FuSa primary chiplet by asserting the corresponding output interrupt wire. When the primary safety entity receives an input interrupt, it may use the FuSa messaging channel to query the source of the interrupt. There may be multiple possible interrupt sources, depending on the number of connected input interrupts, but the system topology may be known in advance. The responding chiplet may either report the reason for the interrupt if the interrupt originated within that chiplet or identify the next downstream source in the chain if interrupt forwarding is being used. It may be the responsibility of the primary safety entity to signal the secondary safety entities when an interrupt may be cleared. After sending the request to clear the last pending interrupt, the primary safety entity may recheck both the fatal error interrupt wire and the non-fatal interrupt wire after a configurable delay. If either the fatal error interrupt wire or the non-fatal interrupt wire remains asserted, it may indicate that one or more additional faults have occurred during or after the clearing sequence, and the primary safety entity may initiate a further fault response accordingly.

The post-clearing recheck mechanism may address a race condition that may otherwise arise during fault clearing. After primary safety entity 431 has identified the source of an asserted interrupt and has issued a clear command via the FuSa messaging channels to the relevant secondary safety entity, a finite interval elapses between transmission of the clear command and the actual de-assertion of the interrupt wire by the secondary safety entity. During this interval, propagation delays, software execution latency in the secondary safety entity, and physical signal settling times may cause the interrupt wire to remain asserted briefly after the clear command has been received. If a second fault occurs in the corresponding chiplet during this clearing interval, the resulting interrupt assertion would be indistinguishable from the residual assertion of the original cleared interrupt, and the second fault could therefore be masked. The post-clearing recheck mechanism may resolve this by causing the primary safety entity to recheck the state of the interrupt wire after a configurable delay following transmission of the clear command. If the wire has de-asserted within the delay, the primary safety entity may treat the interrupt as cleared and the corresponding fault as fully addressed. If the wire remains asserted following the delay, the primary safety entity may treat this as an indication that one or more additional faults have occurred during or after the clearing sequence and may initiate a further fault response, including a renewed query-chain traversal over the FuSa messaging channels to identify the source of the persisting interrupt. The recheck operation may be performed independently for the fatal error interrupt wires and for the non-fatal interrupt wires of a given chiplet, such that a fatal error interrupt wire and a non-fatal interrupt wire of the same chiplet may be in different states at the time of the recheck and may be evaluated separately. Independent recheck of each wire ensures that a second fault on one wire is not masked by the clearing sequence of the other.

The configurable delay used by the post-clearing recheck mechanism may be a profile-dependent or system-defined parameter rather than a fixed architectural value. Selecting an appropriate delay involves a tradeoff: a delay shorter than the worst-case propagation and de-assertion latency of the interrupt wire may cause primary safety entity 431 to incorrectly treat a still-clearing wire as indicating a new fault, while a delay longer than necessary increases the diagnostic interval during which a genuine second fault remains undetected. The configurability of the delay allows the architecture to be tuned to the specific propagation characteristics of the package, including in-package wire routing length, signal settling time of the interrupt receiver, software execution latency of the secondary safety entity, and the diagnostic time interval required by the applicable safety concept. In specific embodiments, the configurable delay may be set during boot of the SiP based on configuration information provided by the SiP integrator, may be tuned at runtime by the primary safety entity in response to observed clearing behavior, or may differ between fatal error interrupt wires and non-fatal interrupt wires of the same chiplet to reflect different latency or criticality profiles for the two wire types.

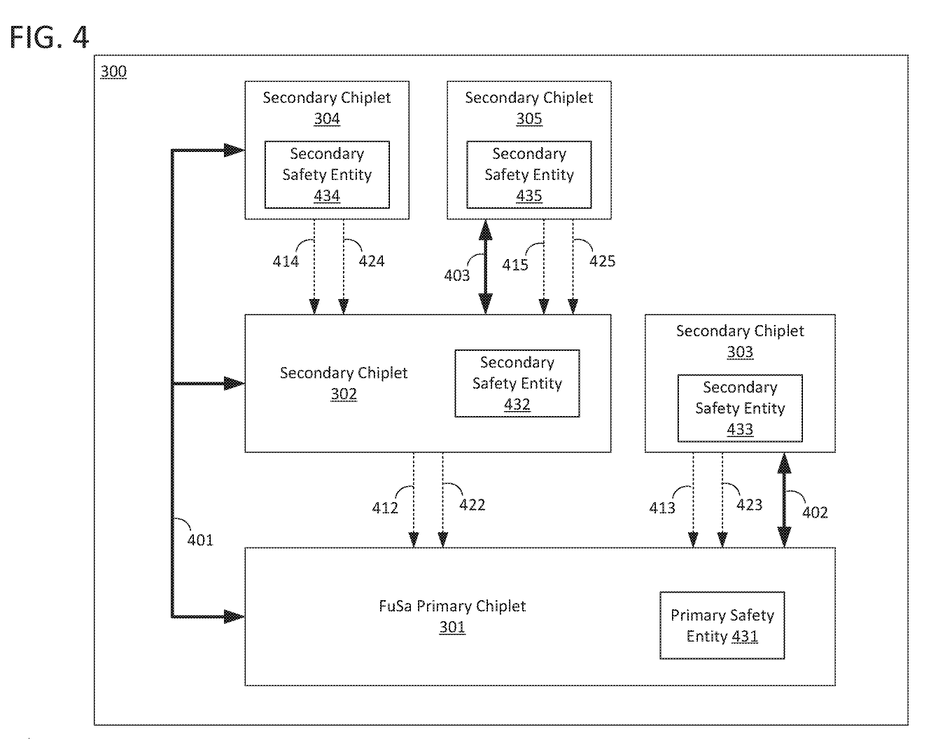

FIG. 4 illustrates SiP 300 with safety entities, FuSa messaging channels, and interrupt channels in accordance with specific embodiments of the inventions disclosed herein. SiP 300 may be considered a network of chiplets. Chiplets 301-305 have their own respective safety entities 431-435. FuSa primary chiplet 301 includes primary safety entity 431. Secondary chiplets 302, 303, 304, and 305 include secondary safety entities 432, 433, 434, and 435 respectively. Each chiplet 302-305 may be connected to primary safety entity 431 via one or more interrupt channels and one or more FuSa messaging channels. Primary safety entity 431 may be coupled with each secondary safety entity 432-435. FuSa messaging channels 401, 402, and 403 are shown as solid bidirectional lines reflecting their bidirectional communication capability, while interrupt channels 412-415 and 422-425 are shown as dashed unidirectional lines reflecting that interrupt signals travel only in one direction — from downstream secondary chiplets toward primary safety entity 431.

In the example of FIG. 4, FuSa messaging channel 401 connects FuSa primary chiplet 301, secondary chiplet 302, and secondary chiplet 304 along a shared communication path; FuSa messaging channel 402 directly connects secondary chiplet 303 and FuSa primary chiplet 301; and FuSa messaging channel 403 directly connects secondary chiplet 302 and secondary chiplet 305, providing an indirect path between secondary chiplet 305 and primary safety entity 431 through secondary chiplet 302. Also in the example of FIG. 4, secondary chiplet 304 sends fatal error interrupts to secondary chiplet 302 through interrupt channel 414; secondary chiplet 304 sends non-fatal interrupts to secondary chiplet 302 through interrupt channel 424; secondary chiplet 305 sends fatal error interrupts to secondary chiplet 302 through interrupt channel 415; secondary chiplet 305 sends non-fatal interrupts to secondary chiplet 302 through interrupt channel 425; secondary chiplet 303 sends fatal error interrupts to FuSa primary chiplet 301 through interrupt channel 413; secondary chiplet 303 sends non-fatal interrupts to FuSa primary chiplet 301 through interrupt channel 423; secondary chiplet 302 sends fatal error interrupts to FuSa primary chiplet 301 through interrupt channel 412; and secondary chiplet 302 sends non-fatal error interrupts to FuSa primary chiplet 301 through interrupt channel 422. Accordingly, secondary chiplet 305 is indirectly connected to primary safety entity 431 via secondary chiplet 302 for both its interrupt channels and its FuSa messaging channel; secondary chiplet 304 is indirectly connected to primary safety entity 431 via secondary chiplet 302 for its interrupt channels and directly connected to primary safety entity 431 for its FuSa messaging channel; and secondary chiplets 302 and 303 are directly connected to primary safety entity 431 for both channel types. In specific embodiments, a software-controlled interrupt self-test mechanism allows each interrupt wire to remain a single physical conductor, minimizing routing complexity within the package while still satisfying diagnostic coverage requirements.

FuSa messaging channels 401, 402, and 403 are bidirectional communication pathways that connect each safety entity 432-435 to primary safety entity 431. Safety entities 431-435 may use the FuSa messaging channels for inter-chiplet communication. The plurality of FuSa messaging channels may be configured to carry safety communication-based communication between the primary safety entity and the plurality of chiplets. Because the FuSa messaging channels are bidirectional, primary safety entity 431 may initiate queries directed toward secondary safety entities 432-435, and secondary safety entities 432-435 may transmit safety communications, query responses, and heartbeat messages toward primary safety entity 431 over the same channels. The FuSa messaging channels may be physically separate from other channels of the package to minimize inter-channel interference. The FuSa messaging channels may be buses or individual lines. The FuSa messaging channels may be used during self-test initiation, interrupt source query and response, and interrupt cause query and response.

The FuSa messaging channels themselves may be subject to faults, such as open-circuit or short-circuit conditions within the package. Most safety standards require that such faults be detectable within a defined time frame. To support this, each chiplet 301-305 may implement a heartbeat — a periodic, predefined message transmitted at a system-defined interval — that primary safety entity 431 can use to verify the integrity of each FuSa messaging channel independently of any fault event. If a heartbeat is not received within the expected interval, primary safety entity 431 may treat this as an indication of a channel fault and initiate an appropriate safety response. The time interval for these heartbeat tests may be defined by the system.

The heartbeat messages may be transmitted in either direction over FuSa messaging channels 401, 402, and 403, or in both directions, depending on the embodiment. In specific embodiments, secondary safety entities 432, 433, 434, and 435 each transmit periodic heartbeat messages toward primary safety entity 431, and primary safety entity 431 monitors the arrival of these heartbeat messages within expected time intervals. In such embodiments, the absence of a heartbeat from a particular secondary safety entity within the expected interval indicates a potential fault on the path from that secondary safety entity to primary safety entity 431, including a fault in the secondary safety entity itself, a fault in any intermediate chiplet on the path, or a fault in the FuSa messaging channel segment connecting them. In other embodiments, primary safety entity 431 transmits periodic heartbeat messages toward each of secondary safety entities 432, 433, 434, and 435, and the secondary safety entities monitor the arrival of these heartbeat messages and report a missed heartbeat to primary safety entity 431 by other means, such as by asserting a non-fatal interrupt wire. In still further embodiments, heartbeat messages are transmitted in both directions, with primary safety entity 431 and each secondary safety entity each generating and monitoring heartbeats independently. Bidirectional heartbeat transmission provides the most comprehensive channel integrity coverage, as it allows detection of asymmetric faults — for example, a fault that prevents traffic from flowing in one direction over the channel while still allowing traffic in the opposite direction — that would otherwise be undetectable using heartbeats in a single direction. The choice of heartbeat directionality may be a profile-dependent or system-defined parameter, selected based on the diagnostic coverage requirements of the applicable safety concept and on the available bandwidth of the FuSa messaging channel.

In embodiments where one or more secondary safety entities are indirectly connected to the primary safety entity through one or more intermediate chiplets, the behavior of the intermediate chiplet with respect to heartbeat traffic depends on the embodiment. In specific embodiments, the intermediate chiplet operates as a transparent relay, forwarding heartbeat messages received on one FuSa messaging channel onto the next FuSa messaging channel in the path without modification. Transparent relay allows the primary safety entity to verify the integrity of the entire path from each secondary safety entity to the primary safety entity as a single end-to-end communication path. In other embodiments, the intermediate chiplet generates its own heartbeat messages on each FuSa messaging channel segment connecting it to its upstream and downstream neighbors, allowing each segment to be verified independently of the others. Per-segment heartbeat generation enables the primary safety entity to localize a detected channel fault to a specific segment of the indirect connection, rather than only to the path as a whole. In still further embodiments, the intermediate chiplet performs both functions — relaying heartbeat messages originated by its downstream neighbors while also generating its own heartbeat messages on each connected segment — providing both end-to-end verification and per-segment fault localization. The aggregation information described in connection with interrupt forwarding may also include information identifying the heartbeat behavior of each intermediate chiplet, allowing primary safety entity 431 to interpret a missed heartbeat appropriately based on the heartbeat configuration in effect for the path.

Secondary safety entities 432-435 may be configured to send one or more safety communications about a chiplet error of the corresponding chiplet 302-305 to primary safety entity 431. Secondary safety entities 432-435 may actively send errors without waiting for a query from primary safety entity 431. Secondary safety entities 432-435 may also be configured to address the error of the corresponding chiplet 302-305 autonomously, before receiving a response from primary safety entity 431. For example, a secondary safety entity may place its own chiplet into reset or initiate another local corrective action.

The plurality of interrupt channels 412-415 and 422-425 connecting each chiplet 302-305 to primary safety entity 431 are in addition to, and physically separate from, FuSa messaging channels 401-403. Because interrupt channels 412-415 and 422-425 are unidirectional point-to-point conductors that operate independently of any protocol stack, they remain available to deliver fault notification to primary safety entity 431 even in the event that a FuSa messaging channel has suffered a fault. Primary safety entity 431 may assume a worst case scenario and implement safety measures accordingly upon receiving an interrupt even if the FuSa messaging channel is unavailable and the specific cause of the fault cannot be determined. For example, primary safety entity 431 may implement measures to prevent harm even if it is unaware of the exact cause of the interrupt. For example, if the chiplet network is part of an automotive system, primary safety entity 431 may take measures to prevent a car crash.

Each safety entity 432-435 may aggregate safety information from downstream chiplets connected to its respective chiplet such that the aggregated safety information is forwarded upstream and ultimately received by primary safety entity 431 for the overall SiP 300. In specific embodiments, the network of chiplets may be connected in a directed tree topology, daisy-chain, or other hierarchical topology. The safety entity of each chiplet may aggregate safety information from downstream chiplets in the network and safety information of the corresponding chiplet. The safety entity of each chiplet may also transmit the aggregated safety information to an upstream chiplet in the network.

In specific embodiments, because interrupt channels 412-415 and 422-425 may be unidirectional conductors that carry only level-sensitive signals, they may not be able to be queried directly. Instead, the integrity of each interrupt channel may be verified through a software-controlled self-test mechanism, in which primary safety entity 431 may instruct a secondary safety entity to assert its interrupt wire under software control and then may observe whether the expected signal is received. Chiplets 301-305 may verify the FuSa messaging channels by monitoring heartbeat messages and by confirming that query responses are received within expected time frames.

In specific embodiments, a FuSa messaging channel may be connected directly between a secondary chiplet and FuSa primary chiplet 301. In SiP 300, secondary safety entities 432 and 433 are directly connected with primary safety entity 431 via FuSa messaging channels 401 and 402 respectively. Secondary safety entity 434 is also directly connected with primary safety entity 431 via FuSa messaging channel 401, which is shared with secondary safety entity 432.

In specific embodiments, a secondary chiplet may be indirectly connected to FuSa primary chiplet 301 through one or more FuSa messaging channels, with the number of intermediate channels depending on the chiplet's location in the directed tree topology. In SiP 300, secondary safety entity 435 is indirectly connected with primary safety entity 431 through secondary safety entity 432 via FuSa messaging channels 403 and 401 in sequence. Each chiplet in the network may be configured to aggregate safety information from downstream chiplets in the network via its secondary safety entity. Each chiplet may also be configured to transmit, via a respective FuSa messaging channel, the aggregated safety information to an upstream chiplet in the network via its secondary safety entity. In the case of an indirect connection, a query on the FuSa messaging channel directed toward an indirectly connected chiplet may first be received by the aggregating intermediate chiplet; if the aggregating chiplet determines that it was not the source of the relevant interrupt, it may relay the query to the next downstream chiplet in the chain.

In specific embodiments, interrupt channels may directly connect a secondary chiplet to FuSa primary chiplet 301. In SiP 300, interrupt channels 412, 422, 413, and 423 directly connect secondary chiplets 302 and 303 to primary safety entity 431. Each of these channels carries a unidirectional signal from the respective secondary chiplet toward primary safety entity 431.

In specific embodiments, interrupt channels may be connected to primary safety entity 431 through intermediate secondary chiplets that aggregate and forward interrupt signals from further downstream chiplets. In SiP 300, interrupt channels 414, 424, 415, and 425 indirectly connect secondary chiplets 304 and 305 with primary safety entity 431 by first connecting to secondary chiplet 302, which may aggregate the incoming interrupt signals and forward them toward primary safety entity 431 via interrupt channels 412 and 422. In specific embodiments, the interrupt channels may connect the chiplets in a directed tree topology. Each chiplet may be configured to aggregate incoming interrupt signals from downstream chiplets in the network and assert its own output interrupt channels accordingly. In specific embodiments, each chiplet in the network may be configured to receive a query directed toward a downstream chiplet on a FuSa messaging channel and relay the query to the appropriate downstream chiplet in the network if the intermediate chiplet determines that it is not itself the source of the interrupt. In specific embodiments, the appropriate downstream chiplet may be another intermediate chiplet that would then also relay the query.

Interrupt channels 412-415 and 422-425 may be dedicated point-to-point wires connecting adjacent chiplets in the directed tree topology. The interrupt channels may be active high. In specific embodiments, the interrupt signals may be asserted using means other than being set to high. For example, the asserted state of the interrupt wire may be high voltage level, a logical one, a low voltage level, a logical zero, a differential signal, a transition between levels, or any other physical convention by which the interrupt wire can convey the presence of an interrupt condition. A fatal error interrupt channel, such as one of channels 412-415, may be asserted (e.g., activated high) to indicate a fatal error of the corresponding chiplet, such as an uncorrectable ECC error or a system hang. A non-fatal interrupt channel, such as one of channels 422-425, may be asserted (e.g., activated high) to indicate a non-fatal error or status event of the corresponding chiplet, such as a corrected ECC error. Both fatal error interrupt channels and non-fatal interrupt channels may be asserted during chiplet reset, indicating that the function is not available and ensuring that primary safety entity 431 is notified of chiplet unavailability even when the chiplet is incapable of protocol-based communication.

Primary safety entity 431 may be configured to transmit a self-test command to a secondary safety entity of a downstream chiplet via the FuSa messaging channels. Upon receiving the self-test command, the targeted safety entity may respond by asserting the applicable interrupt wire — either a fatal error interrupt channel or a non-fatal interrupt channel, or both — under software control, allowing primary safety entity 431 to confirm end-to-end electrical continuity of each wire. After confirming that the asserted interrupt signal has been received, primary safety entity 431 may transmit a clear command via the FuSa messaging channels, and the secondary safety entity may then de-assert the interrupt wire. Clearing the self-test interrupt may cause the secondary safety entity, via software, to de-assert (e.g., set low) the applicable interrupt channel that was previously asserted (e.g., set high) for the test. Chiplets may implement measures to ensure that if a real fault interrupt occurs on either a fatal error interrupt channel or a non-fatal interrupt channel during a self-test, this information can be communicated to primary safety entity 431 via the FuSa messaging channels, preventing a genuine fault from being masked by the test procedure. The fatal error interrupt channels and the non-fatal interrupt channels of a given chiplet may each be tested independently, such that the integrity of each individual wire is verified separately.

The hierarchical aggregation model allows the safety architecture to scale across arbitrarily complex multi-chiplet configurations, including configurations involving daisy-chain, star, and tree topologies, without requiring every chiplet to maintain a direct connection to the primary safety entity. Each interrupt channel and each FuSa messaging channel may be physically separate, making the interrupt path available even under conditions in which the FuSa messaging channel itself has suffered a fault. The primary safety entity may receive notification of a fault condition through a signal path that is independent of any higher-level communication infrastructure, allowing it to assume a worst-case scenario and initiate protective measures even in the absence of detailed fault information.

The FuSa messaging channel may provide the complementary high-fidelity communication path used for fault diagnosis, self-testing, and coordinated fault response. Unlike generic inter-chiplet messaging channels, the properties of the FuSa messaging channel — including cyclic redundancy checks, sequence numbers, timeout enforcement, and periodic heartbeat messages — may be derived directly from safety requirements rather than performance or throughput considerations. The heartbeat mechanism may allow the primary safety entity to continuously verify the integrity of each messaging channel segment independently of any fault event, satisfying safety standards that require channel faults to be detectable within a defined diagnostic interval.

An interrupt forwarding mechanism may allow intermediate chiplets to relay incoming interrupt signals toward the primary safety entity. Upon receiving a forwarded interrupt, the primary safety entity may initiate a query-chain traversal over the FuSa messaging channel, querying the first chiplet in the forwarding path to identify the source of the interrupt. Each intermediate chiplet may either report itself as the source or identify the next chiplet in the chain, allowing the primary safety entity to traverse the topology and reach the original faulting chiplet without requiring advance knowledge of which specific chiplet generated the fault. Each chiplet that participates in interrupt forwarding may record aggregation information identifying which downstream chiplets contributed to its output interrupt state, and provides this information to the primary safety entity upon query, enabling precise fault source identification in arbitrarily deep forwarding chains.

After issuing a request to clear the last pending interrupt, the primary safety entity may be configured to recheck the state of the interrupt line after a configurable delay. If the interrupt line remains asserted following this delay, the primary safety entity may treat this as an indication that additional faults have occurred during or after the clearing sequence, and may initiate a further fault response accordingly. This recheck mechanism closes a potential gap in fault detection that could otherwise arise if a second fault occurs in the interval between the clearing request and the confirmation of the cleared state.

The functional safety architecture disclosed herein provides several benefits relative to conventional approaches to safety in multi-chiplet systems. The hierarchical directed-tree topology with autonomous secondary safety entities at each chiplet enables the architecture to scale across heterogeneous multi-chiplet configurations, including configurations involving chiplets supplied by different vendors and manufactured using different processes, without requiring every chiplet to maintain a direct connection to the primary safety entity. The dual-channel architecture, comprising physically separate wired interrupt channels and a functional safety messaging channel, provides redundant and complementary fault notification paths, allowing the primary safety entity to receive fault notification through the wired interrupt channel even when the functional safety messaging channel itself has suffered a fault, and conversely allowing detailed fault diagnosis over the FuSa messaging channel once a fault has been signaled. The autonomous fault-handling capability of the secondary safety entities reduces the interval between fault occurrence and initial containment, which is critical in applications with strict fault-response timing requirements such as those imposed by ISO 26262 and IEC 61508. The interrupt forwarding mechanism, combined with the recording of aggregation information at each forwarding chiplet and the query-chain traversal performed by the primary safety entity over the FuSa messaging channel, enables precise fault source identification in arbitrarily deep forwarding chains while reducing the number of interrupt input wires required at the primary safety entity and accommodating physical layout constraints within the package. The software-controlled interrupt self-test mechanism allows each interrupt wire to remain a single physical conductor, minimizing in-package routing complexity while still satisfying the diagnostic coverage requirements of applicable safety standards, and the inclusion of mechanisms to prevent self-test masking ensures that genuine faults occurring during a self-test are not lost. The heartbeat-based channel integrity monitoring satisfies safety standard requirements for detecting communication channel faults within bounded diagnostic time intervals, independently of any fault event in the connected chiplets. The post-clearing recheck mechanism with configurable delay closes a race condition that could otherwise allow a second fault to be masked by the clearing sequence of a first fault. The reset-state assertion of the fatal error interrupt establishes a default-offline signaling convention that prevents a silent or unresponsive chiplet from being treated as healthy. The interoperable FuSa frameworks described herein support compliance with applicable safety standards, accommodate heterogeneous chiplet integration, and provide graceful degradation in the presence of faults across all communication paths within the system.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to an SIP, safety mechanisms may be applicable to any system that is a combination of chiplets (or chips). These and other modifications and variations to the present invention may be practiced by those skilled in the art, without departing from the scope of the present invention, which is more particularly set forth in the appended claims.

What is claimed is:

1. A network comprising:
a plurality of chiplets, each chiplet including a safety entity; and
a primary safety entity coupled with each safety entity;
wherein the safety entity of each chiplet is configured to: (i) send one or more safety communications about a chiplet error of the corresponding chiplet to the primary safety entity; and (ii) address the chiplet error of the corresponding chiplet.

2. A network comprising:
a plurality of chiplets, each chiplet including a safety entity;
a primary safety entity; and
a plurality of functional safety messaging channels connecting each chiplet in the plurality of chiplets to the primary safety entity, wherein the plurality of functional safety messaging channels are configured to carry safety communications between the primary safety entity and the plurality of chiplets.

3. The network of claim 2, further comprising:
a plurality of interrupt channels connecting each chiplet in the plurality of chiplets to the primary safety entity.

4. The network of claim 3, wherein the plurality of interrupt channels are physically separate from the plurality of functional safety messaging channels.

5. The network of claim 4, wherein the plurality of interrupt channels comprises, for each chiplet in the plurality of chiplets:
a fatal error interrupt wire configured to indicate a fatal error of the corresponding chiplet; and
a non-fatal interrupt wire that is physically separate from the fatal error interrupt wire and configured to indicate a non-fatal error or a status event of the corresponding chiplet.

6. The network of claim 3, wherein the primary safety entity is configured, in response to receiving an asserted interrupt signal forwarded over an interrupt channel of the plurality of interrupt channels, to:
transmit a query over a functional safety messaging channel of the plurality of functional safety messaging channels to a chiplet that asserted the interrupt signal;
receive, in response to the query, an identification of a downstream chiplet from which the asserted interrupt signal was forwarded; and
iteratively transmit further queries to identified downstream chiplets until a chiplet reporting a local fault as a source of the interrupt signal is identified.

7. The network of claim 3, wherein the primary safety entity is configured to:
transmit a clear command over a functional safety messaging channel of the plurality of functional safety messaging channels to clear an asserted interrupt;
determine, after a configurable delay following transmission of the clear command, whether an interrupt channel of the plurality of interrupt channels remains asserted; and
initiate a further fault response in response to determining that the interrupt channel remains asserted following the configurable delay.

8. The network of claim 3, wherein each interrupt channel in the plurality of interrupt channels connects the respective chiplet directly to the primary safety entity.

9. The network of claim 3, wherein:
the plurality of interrupt channels connect the plurality of chiplets in a directed tree topology; and
each chiplet in the plurality of chiplets is configured to: (i) aggregate interrupt signals from downstream chiplets in the plurality of chiplets into an aggregated interrupt signal; and (ii) transmit, via a respective interrupt channel, the aggregated interrupt signal to an upstream chiplet in the plurality of chiplets.

10. The network of claim 9, wherein each chiplet in the plurality of chiplets is configured to:
receive a query on a functional safety message channel of the plurality of functional safety messaging channels;
determine whether the query relates to that chiplet; and
relay the query to another chiplet in the plurality of chiplets if the query does not relate to that chiplet.

11. The network of claim 10, wherein each chiplet in the plurality of chiplets is configured to:
record aggregation information identifying which one or more downstream chiplets in the plurality of chiplets contributed to an asserted output interrupt state of the chiplet; and
in response to a query received over a functional safety messaging channel of the plurality of functional safety messaging channels, transmit at least a portion of the aggregation information to the primary safety entity.

12. The network of claim 3, wherein each interrupt channel in the plurality of interrupt channels are wires directly between chiplets in the plurality of chiplets.

13. The network of claim 12, wherein an interrupt channel in the plurality of interrupt channels is asserted to indicate an interrupt from a chiplet directly coupled with the interrupt channel.

14. The network of claim 13, wherein the interrupt channel is asserted based on a fatal error of the chiplet.

15. The network of claim 13, wherein the interrupt channel is asserted based on a non-fatal error of the chiplet.

16. The network of claim 15, wherein the non-fatal error is a corrected error.

17. The network of claim 12, wherein an interrupt channel in the plurality of interrupt channels is asserted during a chiplet reset of a chiplet directly coupled with the interrupt channel.

18. The network of claim 17, wherein the primary safety entity is configured to:
treat the chiplet as offline while the interrupt channel is asserted during the chiplet reset; and
treat the chiplet as available based on de-assertion of the interrupt channel by the chiplet following completion of the chiplet reset.

19. The network of claim 2, wherein each chiplet in the plurality of chiplets is configured to query a respective functional safety messaging channel in the plurality of functional safety messaging channels to determine whether the respective functional safety messaging channel is functional.

20. The network of claim 2, wherein each functional safety messaging channel in the plurality of functional safety messaging channels connects a respective chiplet directly to the primary safety entity.

21. The network of claim 2, wherein:
the plurality of functional safety messaging channels connect the plurality of chiplets in a directed tree topology; and
each chiplet in the plurality of chiplets is configured to: (i) aggregate safety information from downstream chiplets in the plurality of chiplets; and (ii) transmit, via a respective functional safety messaging channel, the aggregated safety information to an upstream chiplet in the plurality of chiplets.

22. The network of claim 2, wherein:
each chiplet in the plurality of chiplets is configured to transmit, over a respective functional safety messaging channel of the plurality of functional safety messaging channels, a periodic heartbeat message at a defined interval; and
the primary safety entity is configured to indicate a fault of the respective functional safety messaging channel in response to a heartbeat message not being received within the defined interval.

23. The network of claim 2, wherein:
the primary safety entity is configured to transmit a self-test interrupt to the safety entity of a chiplet in the plurality of chiplets via the plurality of functional safety messaging channels; and
the safety entity that receives the self-test interrupt is configured to clear the self-test interrupt via the plurality of functional safety messaging channels.

24. The network of claim 23, further comprising:
an interrupt channel connecting the chiplet to the primary safety entity; wherein the safety entity is configured to assert the interrupt channel under software control in response to receiving the self-test interrupt;
wherein the safety entity is further configured, in response to detecting a fault of the chiplet during assertion of the interrupt channel for the self-test interrupt, to communicate the fault to the primary safety entity via the plurality of functional safety messaging channels in a manner distinguishable from the self-test interrupt.

25. The network of claim 23, further comprising:
an interrupt channel connecting the chiplet to the primary safety entity;
wherein clearing the self-test interrupt comprises the safety entity, via software, de-asserting the interrupt channel.

26. A network comprising:
a plurality of chiplets, each chiplet including a safety entity; and
a plurality of chiplet connections connecting the plurality of chiplets in a directed tree topology;
wherein the safety entity of each chiplet: (i) aggregates safety information from downstream chiplets in the plurality of chiplets and safety information of the corresponding chiplet; and (ii) transmits the aggregated safety information to an upstream chiplet in the plurality of chiplets.
